(19) United States
(12) Patent Application Publication
(10) Pub. No.: US 2016/0234584 A1
(43) Pub. Date: Aug. 11, 2016

(54) AMATHOPHOBIC SPEAKER SYSTEMS

(71) Applicant: Mitek Corp., Inc., Phoenix, AZ (US)

(72) Inventor: Johnathan Ivey, Chandler, AZ (US)

(21) Appl. No.: 14/737,368

(22) Filed: Jun. 11, 2015

Related U.S. Application Data
(60) Provisional application No. 62/112,939, filed on Feb. 6, 2015.

(51) Int. Cl. H04R 1/02; H04R 9/06

(52) U.S. Cl. CPC H04R 1/02; H04R 9/06

(57) ABSTRACT

A speaker system having internal and external static and dynamic constituent speaker parts at least partially coated with an amathophobic coating to prevent dust accumulations that would interfere with performance. Objects associated with the speaker, such as a speaker grill, power supply, speaker support, or speaker enclosure may also be at least partially coated with an amathophobic coating to prevent dust accumulations that would interfere with performance.

### RELATED APPLICATIONS

This application claims the benefit of U.S. provisional patent application No. 62/112,939 filed Feb. 6, 2015 to the same inventor.

### FIELD OF ART

The present invention relates to a loudspeaker having dynamic and static parts to which dust cannot adhere. In particular, the invention relates to parts of the system that are at least partially coated with an amathophobic coating.

### BACKGROUND OF THE INVENTION

“Amathophobia” is the fear of dust. Amathophobic coatings are coatings to which dust does not adhere. Loudspeakers undesirably accumulate dust that can degrade speaker performance and sound quality. For example, a foraminous speaker grill can become clogged with dust which dampens the sound to the listener. For further example, dust can accumulate on dynamic surfaces, such as the spider, the coil, the surround, or the diaphragm. Such accumulations can change the mass of the part to which the dust attaches, thereby affecting system dynamics and degrading sound quality. For a further example, electrical contacts for the speaker inputs may be bridged by dust, thereby affecting the circuit and degrading sound quality. For another example, the air gap of a loudspeaker may accumulate dust, thereby changing the volume of the air gap and so the dynamics of the coil.

### SUMMARY OF THE INVENTION

Briefly described, the invention includes a speaker system having at least one of internal and external static and dynamic constituent speaker parts at least partially coated with an amathophobic coating to prevent dust accumulations that would interfere with performance. Objects associated with the speaker, such as a speaker grill, power supply, speaker support, or speaker enclosure may also be at least partially coated with an amathophobic coating to prevent dust accumulations that would interfere with performance.

### DESCRIPTION OF THE FIGURES OF THE DRAWINGS

The present invention will hereinafter be described in conjunction with the following drawing figures, wherein like numerals denote like elements, and

FIG. 1 is a plan view illustrating an exemplary embodiment of an exemplary speaker grill, according to a preferred embodiment of the present invention;

FIG. 2 is a front perspective view illustrating an exemplary embodiment of a detail of the speaker grill of FIG. 1, according to a preferred embodiment of the present invention;

FIG. 3 is a front perspective cutaway view illustrating an exemplary embodiment of the dust free speaker system, according to a preferred embodiment of the present invention; and

FIG. 4 is am exploded perspective view illustrating another exemplary embodiment of the dust free speaker system, according to a preferred embodiment of the present invention.

### DETAILED DESCRIPTION OF THE INVENTION

As used and defined herein, “speaker” is means an audio loudspeaker.

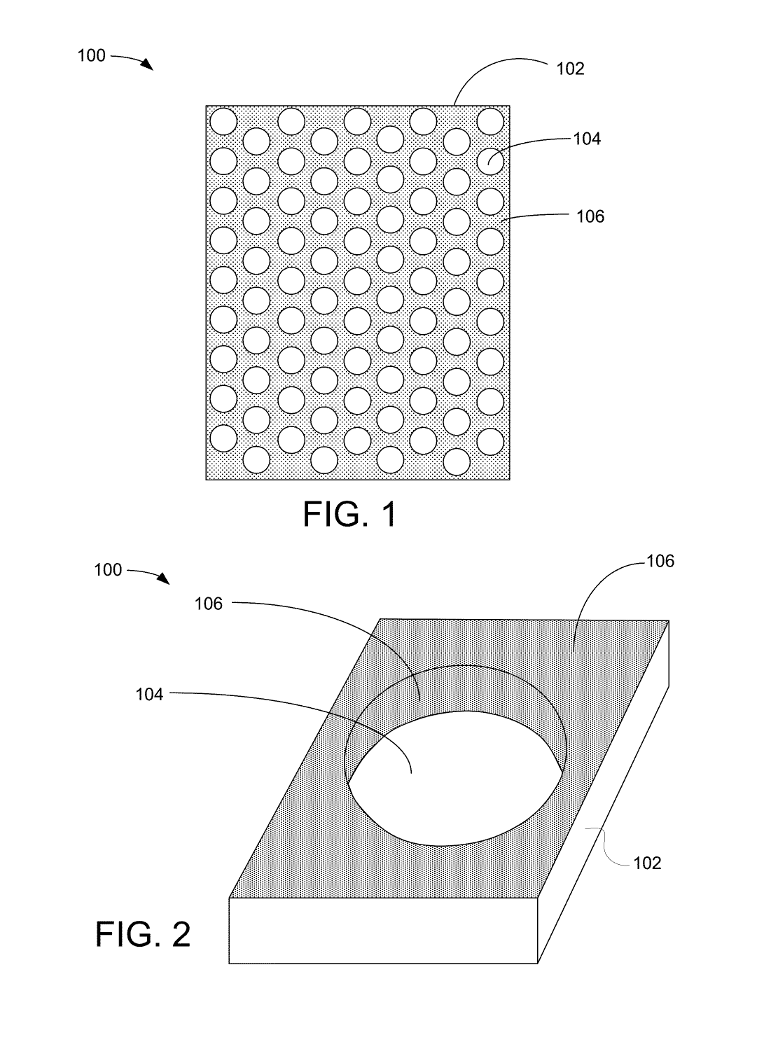

FIG. 1 is a plan view illustrating an exemplary embodiment of an exemplary amathophobic speaker grill 100, according to a preferred embodiment of the present invention. Speaker grill 100 is a foraminous panel 102 having multiple foramina (holes) 104 for the passage of sound. Panel 102 has an amathophobic coating 106 on both sides of speaker grill 102. The coating may be, for non-limiting example, that described in U.S. Published Patent Application U.S. 20120024312 A1 or equivalent commercially available amathophobic (dust-free) coating 106. While panel 102 is illustrated as flat and rectangular, the invention is not so limited. In additional embodiments, panel 102 may be curved, multiply curved, or angled and may have a perimeter of any desired shape. The spacing, sizing, and shape parameters of foramina 104 are determined based on speaker dynamics (frequency range, power, etc.), and the foramina parameters must be adjusted to account for the amathophobic coating 106. The amathophobic coating may also be hydrophobic and/or oleophobic.

FIG. 2 is a front perspective view illustrating an exemplary embodiment of a detail of the speaker grill 100 of FIG. 1, according to a preferred embodiment of the present invention. The amathophobic coating 106 is applied to the bore surfaces of the foramina 104 in addition to both sides of panel 102. Accordingly, the sizes, shapes, and spacing of the foramina, when initially formed in panel 102, must take into account the thickness of the amathophobic coating 106 to be applied. For some amathophobic coatings 106, a layer is deposited and then reduced by wiping or use of a squeegee. For non-limiting example, for the inner walls of the foramina 104, the same drilling jig and CAM program used to drill the holes 104 can be used to reduce the coating 106 within the foramina by using a smaller drill bit.

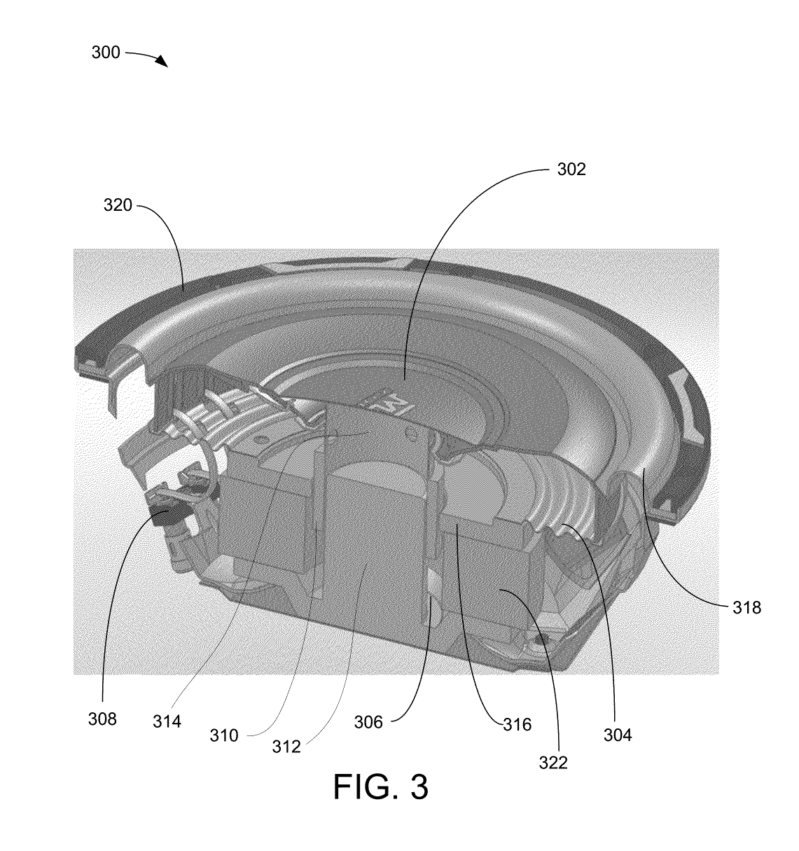

FIG. 3 is a front perspective cutaway view illustrating an exemplary embodiment of a amathophobic speaker system 300, according to a preferred embodiment of the present invention. Loudspeaker 300 includes a number of constituent parts including a diaphragm 302, a surround 314, and a basket 318 (illustrated by the rim of the basket). A diaphragm 302 sometimes includes a central cap which, for present purposes, will be regarded as part of the diaphragm 302. With the top of diaphragm 302, the top of surround 314, and the top of basket 318 rim coated with amathophobic coating 106, the entire acoustic face of the speaker is made dust resistant. Such a speaker 300 may have both general application and also particular application in desert environments. In particular embodiments, additional areas of amathophobic coating 106 may be used on additional portions of the diaphragm 302, surround 314, and basket 318, adaptive to anticipated use environments and speaker design.

Loudspeaker 300 also includes a former 314, a coil 310, and a spider 304, all of which are internal dynamic constituent parts. Coating the interior of the former 314 with amathophobic coating 106 reduces dust accumulation between the former 314 and the central magnetic pole piece 312, thereby assisting in keeping air gap 306 unobstructed. Coil 310 is wound on former 314 and also oscillates in air gap 306, so an amathophobic coating 106 on coil 310 will also assist in keeping air gap 306 unobstructed. Spider 304 preferably has amathophobic coating 106 on both sides, as the spider 304 is a spring in a spring-mass-damper system and changes to its mass properties, as by dust accumulation, can affect speaker 300 performance.

Loudspeaker 300 also includes magnetic materials as constituent parts, including magnet 322, pole piece 312, and air gap plate 316. Pole piece 312 and air gap plate 316 conduct magnetic lines of force from magnet 322. Amathophobic coating 106 on portions of surfaces of magnetic materials that form the air gap 306 will assist in keeping the air gap 306 free of dust.

Loudspeaker 300 also includes electrical contacts 308, each of which is coated with amathophobic coating 106 to prevent bridging of the contacts by dust. For each of the external dynamic constituent parts (the diaphragm 302 and the surround 304) and the internal dyamis constituent parts (former 314, coil 310, and spider 304), the effect of the amathophobic coating 106 on the acoustics of the speaker 300 must be determined and the design of the speaker 300 adapted to accommodate the effects.

The air gap 306 is preferably coated on all interior surfaces. The sizing of the elements making up the air gap must be adapted to ensure proper clearances after amathophobic coating 106 is applied. The entire circumferential surface of the central magnetic pole piece 312 may be beneficially coated to prevent dust accumulation between the pole piece 312 and the former 314 on which the coil 310 is wound. The electrical contacts 308 are coated peripherally to avoid interfering with electrical connections but preventing a dust bridge from forming. The scope of the invention covers a loudspeaker with at least one at least partially amathophobic coated constituent part as well as each amathophobic coated part.

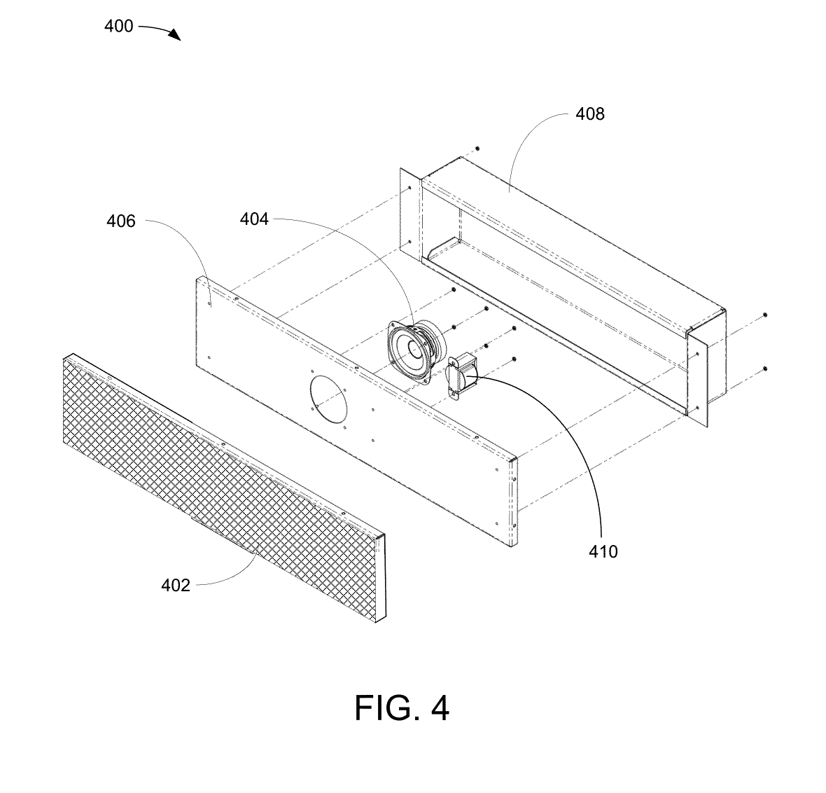

FIG. 4 is an exploded perspective view illustrating another exemplary embodiment of a amathophobic speaker system 400, according to a preferred embodiment of the present invention. Foraminous speaker grill 402 does not attach directly to speaker 404 but is coated as described in relation to FIGS. 1 and 2. Speaker 404 is coupled to speaker support panel 406 and grill 402 is fastened to speaker support panel 406, which itself is fastened to speaker enclosure 408. Speaker support panel 406 is exemplary of a wide variety of speaker supports that may benefit from an amathophobic coating 106. Speaker 404 may be speaker 300 with its amathophobic coatings 106. Power supply 410 is attached to speaker 404 via speaker support panel 406 and may also have an amathophobic coating 106, at least around its electrical contacts, to prevent dust bridging. Ceiling speaker installations like amathophobic speaker system 400 may be in place for decades, and dust accumulations over such a time span can be large. FIG. 4 illustrates that amathophobic coated objects of the amathophobic speaker system 400 do not have to be within, or be directly attached to, speaker 404.

While applicant has provided exemplary embodiments, the invention is not so limited, but includes embodiments that apply to a wide variety of speaker designs, constituent parts, and associated objects.

I claim:

1. An amathophobic speaker assembly comprising:
a. at least one constituent part of a speaker; and
b. an amathophobic coating at least partially coating at least one of:
i. at least a portion of said constituent part; and
ii. at least a portion of an object configured to be associated with said at least one constituent part by attachment.

2. The amathophobic speaker assembly of claim 1, wherein said attachment comprises direct attachment.

3. The amathophobic speaker assembly of claim 1, wherein said at least one constituent part of a speaker comprises a diaphragm.

4. The amathophobic speaker assembly of claim 1, wherein said at least one constituent part of a speaker comprises a spider.

5. The amathophobic speaker assembly of claim 1, wherein said at least one constituent part of a speaker comprises a coil.

6. The amathophobic speaker assembly of claim 1, wherein said at least one constituent part of a speaker comprises an electrical coupling.

7. The amathophobic speaker assembly of claim 1, wherein said at least one constituent part of a speaker comprises a magnetic material.

8. The amathophobic speaker assembly of claim 1, wherein said at least one object associated configured to be associated with said at least one constituent part comprises a speaker grill.

9. The amathophobic speaker assembly of claim 8, wherein said amathophobic coating at least partially coating a portion of said speaker grill comprises said amathophobic coating on inner surfaces of foramina in said speaker grill.

10. The amathophobic speaker assembly of claim 1, wherein said at least one object associated configured to be associated with said at least one constituent part comprises a speaker housing.

11. The amathophobic speaker assembly of claim 1, wherein said at least one object associated configured to be associated with said at least one constituent part comprises a power supply.

12. An amathophobic speaker assembly comprising:
a. at least one constituent part of a speaker; and
b. an amathophobic coating at least partially coating at least one of:
i. at least a portion of said constituent part; and
ii. at least a portion of an object configured to be associated with said at least one constituent part by attachment; and
c. wherein said at least one constituent part of a speaker comprises at least one of:
i. a diaphragm;
ii. a spider;
iii. a coil;
iv. a former;
v. an electrical connection;
vi. a magnetic material;
vii. a basket; and
viii. a surround.

13. The amathophobic speaker assembly of claim 12, wherein said at least one object associated configured to be associated with said at least one constituent part comprises a speaker grill.

14. The amathophobic speaker assembly of claim 13, wherein said amathophobic coating at least partially coating at least a portion of said speaker grill comprises said amathophobic coating on inner surfaces of foramina in said speaker grill.

15. The amathophobic speaker assembly of claim 12, wherein said at least one object associated configured to be associated with said at least one constituent part comprises at least one of a speaker enclosure, a speaker support, and a power supply.

16. An amathophobic speaker assembly comprising:
a. at least one constituent part of a speaker; and
b. an amathophobic coating at least partially coating at least one of:
i. at least a portion of said constituent part; and
ii. at least a portion of at least one object configured to be associated with said at least one constituent part by attachment; and
c. wherein said at least one object comprises at least one of:
i. a speaker grill;
ii. a speaker enclosure;
iii. a speaker support; and
iv. a power supply.

17. The amathophobic speaker assembly of claim 16, wherein said amathophobic coating amathophobic coating at least partially coating at least a portion of said at least one object comprises said amathophobic coating on inner surfaces of foramina in said speaker grill.

18. The amathophobic speaker assembly of claim 16, wherein said at least one constituent part of a speaker comprises at least one of a diaphragm, a surround, and a basket.

19. The amathophobic speaker assembly of claim 16, wherein said at least one constituent part of a speaker comprises at least one of a former, a coil, and a spider.

20. The amathophobic speaker assembly of claim 16, wherein said at least one constituent part of a speaker comprises at least one of a magnetic material and an electrical connection.
